(19) United States
(12) Patent Application Publication
(10) Pub. No.: US 2007/0156960 A1
(43) Pub. Date: Jul. 5, 2007

(54) Ordered combination of uncacheable writes

(76) Inventors: Anil Vasudevan, Portland, OR (US); Parthasarathy Sarangam, Portland, OR (US); Sujoy Sen, Portland, OR (US)

Correspondence Address: Caven & Aghevli LLC;c/o PortfolioIP, P.O. Box 52050, Minneapolis, MN, 55402, US

(21) Appl. No.: 11/323,793

(22) Filed: Dec. 30, 2005

(51) Int. Cl. G06F 12/00

(52) U.S. Cl. 711/118

(57) ABSTRACT

Methods and apparatus to reduce the number of uncacheable write requests are described. In one embodiment, a single uncacheable write request is sent instead of a plurality of uncacheable write requests to an address.

### BACKGROUND

The present disclosure generally relates to the field of electronics. More particularly, an embodiment of the invention relates to ordered combination of uncacheable writes.

Write or store operations in a computing device may be flagged as uncacheable (UC), e.g., to maintain strict ordering of data transfers. For example, various data packets corresponding to a digitized voice conversation (such as a call over the Internet) may need to maintain their strict ordering for conversational coherence. When multiple applications are sending data (e.g., especially smaller packets of input/output (I/O) data), each transaction can result in an uncacheable write. The number of such transactions is dependent on application behavior and, consequently, non-deterministic which in turn results in challenges when designing computing devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 3, and 5 illustrate block diagrams of embodiments of computing systems, which may be utilized to implement various embodiments discussed herein.

FIG. 2 illustrates a block diagram of portions of a processor core, according to an embodiment of the invention.

FIG. 4 illustrates a block diagram of an embodiment of a method to send a single uncacheable write request for a plurality of uncacheable write requests.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

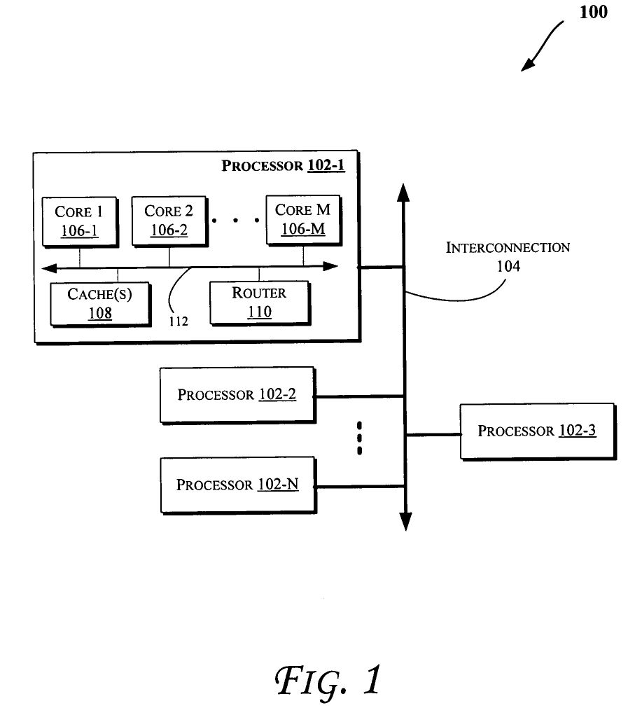

Some of the embodiments discussed herein may provide efficient mechanisms for sending a single uncacheable write request in place of a plurality of uncacheable write requests to the same address. Sending a single uncacheable write request over a bus may conserve bus bandwidth, decrease latency, and/or increase overall throughput in various computing systems, such as those discussed with reference to FIGS. 1, 3, and 5. More particularly, FIG. 1 illustrates a block diagram of a computing system 100, according to an embodiment of the invention. The system 100 may include one or more processors 102-1 through 102-N (generally referred to herein as “processors 102”). The processors 102 may communicate via an interconnection or bus 104. Each of the processors may include various components some of which are only discussed with reference to processor 102-1 for clarity. Accordingly, each of the remaining processors 102-2 through 102-N may include the same or similar components discussed with reference to the processor 102-1. Additionally, the embodiments discussed herein are not limited to multiprocessor computing systems and may be applied in a single-processor computing system.

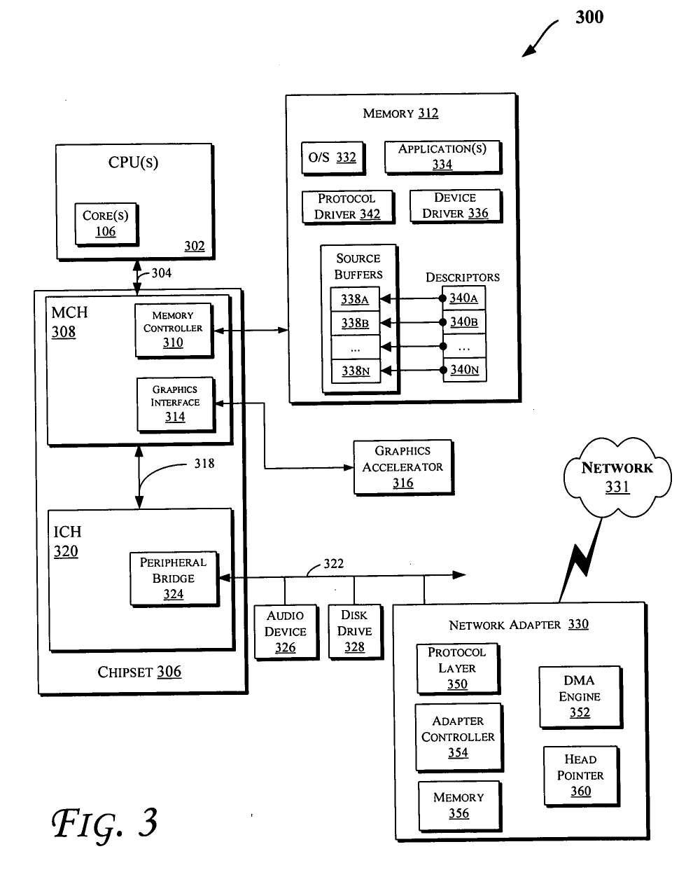

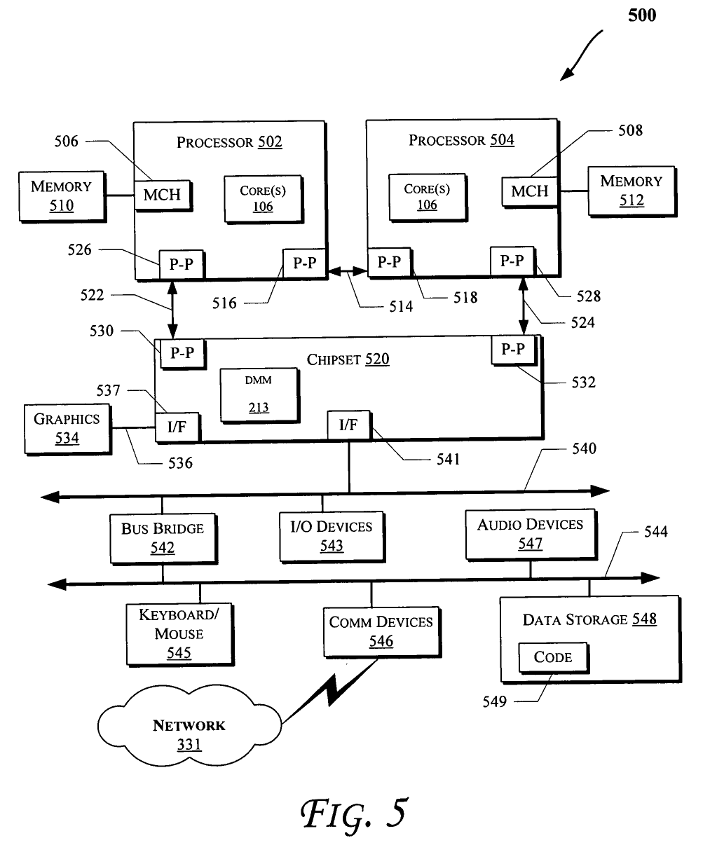

In an embodiment, the processor 102-1 may include one or more processor cores 106-1 through 106-M (referred to herein as “cores 106,” or more generally as “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus 112), memory controllers (such as those discussed with reference to FIGS. 3 and 5), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

Additionally, the cache 108 may store data (e.g., including instructions) that are utilized by one or more components of the processor 102-1. In an embodiment, the cache 108 (that may be shared) may include one or more of a level 2 (L2) cache, a last level cache (LLC), or other types of cache. Also, one or more of the cores 106 may include a level 1 (L1) cache. Various components of the processor 102-1 may communicate with the cache 108 directly, through a bus (e.g., the bus 112), and/or a memory controller or hub. Also, the processor 102-1 may include more than one cache 108.

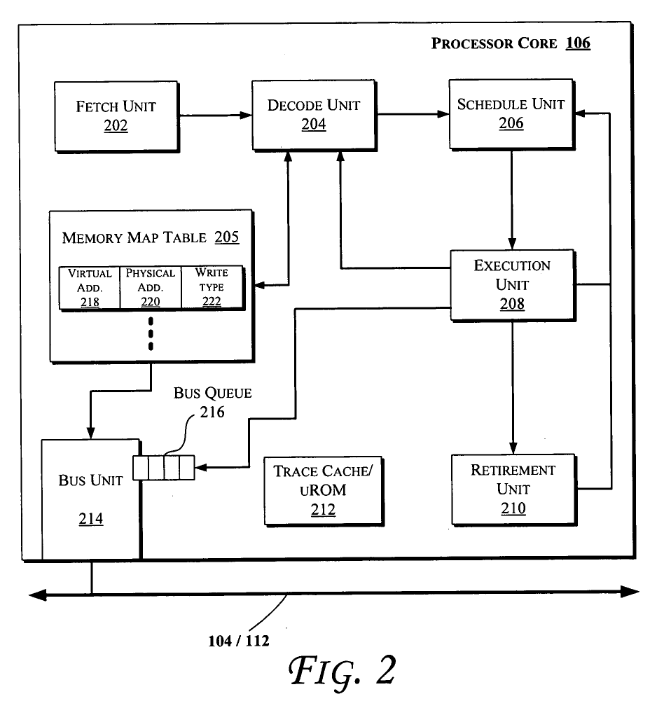

FIG. 2 illustrates a block diagram of portions of a processor core 106, according to an embodiment of the invention. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

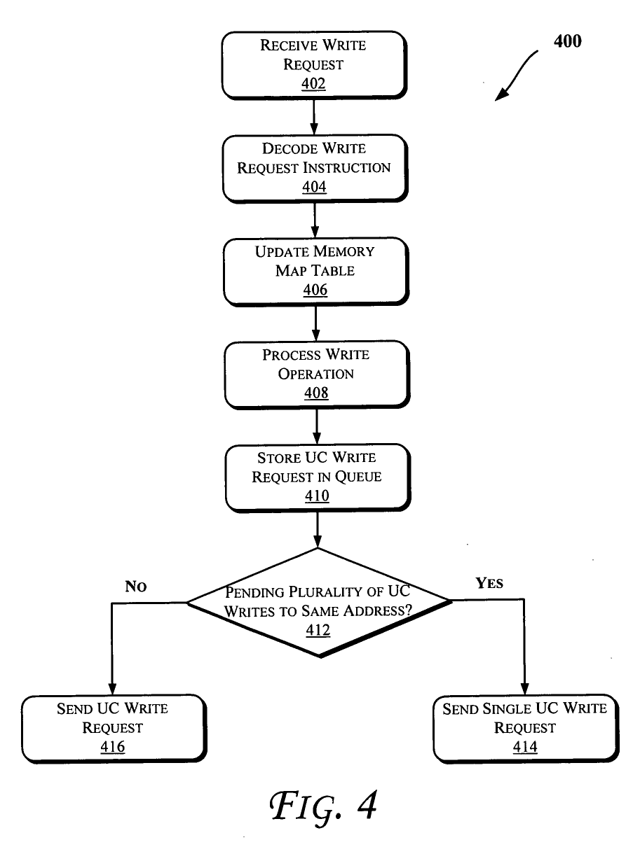

As illustrated in FIG. 2, the processor core 106 may include a fetch unit 202 to fetch instructions for execution by the core 106. The instructions may be fetched from any storage devices such as the memory devices discussed with reference to FIGS. 3 and 5. The core 106 may also include a decode unit 204 to decode the fetched instruction. For instance, the decode unit 204 may decode the fetched instruction into a plurality of uops (micro-operations). The decode unit 204 may communicate with a memory map table 205 that stores information corresponding to a plurality of write requests, as will be further discussed herein, for example, with reference to FIGS. 3 and 4. In one embodiment, the table 205 may be stored in a cache such as the cache 108 of FIG. 1 and/or an L1 cache within the processor core 106 (not shown).

Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206). In an embodiment, the execution unit 208 may include more than one execution unit, such as a memory execution unit, an integer execution unit, a floating-point execution unit, or other execution units. Further, the execution unit 208 may execute instructions out-of-order; hence, the processor core 106 may be an out-of-order processor core in one embodiment. The core 106 may also include a retirement unit 210. The retirement unit 210 may retire executed instructions after they are committed. In an embodiment, retirement of the executed instructions may result in processor state being committed from the execution of the instructions, physical registers used by the instructions being de-allocated, etc.

As illustrated in FIG. 2, the core 106 may additionally include a trace cache or microcode read-only memory (uROM) 212 to store microcode and/or traces of instructions that have been fetched (e.g., by the fetch unit 202). The microcode stored in the uROM 212 may be used to configure various hardware components of the core 106, e.g., for sending a single uncacheable write request in place of a plurality of uncacheable write requests to the same address. In an embodiment, the microcode stored in the uROM 212 may be loaded from another component in communication with the processor core 106, such as a computer-readable medium or other storage device discussed with reference to FIGS. 3 and 5.

The execution unit 208 may communicate with a bus unit 214 via a bus queue 216. For example, the execution unit 208 may send uncacheable write requests to the bus unit 208 for transmission over an interconnection (e.g., the interconnection 104 and/or 112 of FIG. 1). The bus queue 216 may store the information that is to be communicated to various components in communication with the interconnection 104 and/or 112.

FIG. 3 illustrates a block diagram of an embodiment of a computing system 300. The computing system 300 may include one or more central processing unit(s) (CPUs) or processors 302 that communicate with an interconnection (or bus) 304. In an embodiment, the processors 302 may be the same as or similar to the processors 102 of FIG. 1. Also, the interconnection 304 may be the same as or similar to the interconnections 104 and/or 112 discussed with reference to FIG. 1. The processors 302 may include any type of a processor such as a general purpose processor, a network processor (e.g., a processor that processes data communicated over a computer network), or another processor, including a reduced instruction set computer (RISC) processor or a complex instruction set computer (CISC) processor. Moreover, the processors 302 may have a single or multiple core design, e.g., including one or more processor cores (106) such as discussed with reference to FIG. 1. The processors 302 with a multiple core design may integrate different types of processor cores on the same integrated circuit (IC) die. Also, the processors 302 with a multiple core design may be implemented as symmetrical or asymmetrical multiprocessors.

As shown in FIG. 3, a chipset 306 may communicate with the interconnection 304. The chipset 306 may include a memory control hub (MCH) 308. The MCH 308 may include a memory controller 310 that communicates with a memory 312. The memory 312 may store data and sequences of instructions that are executed by the processors 302, or any other device in communication with the computing system 300. In one embodiment of the invention, the memory 312 may include one or more volatile storage (or memory) devices such as random access memory (RAM), dynamic RAM (DRAM), synchronous DRAM (SDRAM), static RAM (SRAM), or other volatile memory devices. Nonvolatile memory may also be used such as a hard disk. Additional devices may communicate via the interconnection 304, such as multiple processors and/or multiple system memories.

The MCH 308 may additionally include a graphics interface 314 in communication with a graphics accelerator 316. In one embodiment, the graphics interface 314 may communicate with the graphics accelerator 316 via an accelerated graphics port (AGP). In an embodiment of the invention, a display (such as a flat panel display) may communicate with the graphics interface 314 through, for example, a signal converter that translates a digital representation of an image stored in a storage device such as video memory or system memory into display signals that are interpreted and displayed by the display. In various embodiments, the display signals produced by the display device may pass through various control devices before being interpreted by and subsequently displayed on the display.

Furthermore, a hub interface 318 may enable communication between the MCH 308 and an input/output (I/O) control hub (ICH) 320. The ICH 320 may provide an interface to I/O devices in communication with the computing system 300. The ICH 320 may communicate with a bus 322 through a peripheral bridge (or controller) 324, such as a peripheral component interconnect (PCI) bridge or a universal serial bus (USB) controller. The bridge 324 may provide a data path between the processor 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments of the invention, integrated drive electronics (IDE) or small computer system interface (SCSI) hard drive(s), USB port(s), a keyboard, a mouse, parallel port(s), serial port(s), floppy disk drive(s), or digital data support interfaces (e.g., digital video interface (DVI)).

The bus 322 may communicate with an audio device 326, one or more disk drive(s) 328, and a network adapter 330. The network adapter 330 may communicate with a computer network 331, e.g., enabling various components of the system 300 to send and/or receive data over the network 331. Other devices may communicate through the bus 322. Also, various components (such as the network adapter 330) may communicate with the MCH 308 in some embodiments of the invention. In addition, the processor 302 and the MCH 308 may be combined to form a single chip. Furthermore, the graphics accelerator 316 may be included within the MCH 308 in other embodiments of the invention.

In an embodiment, the computing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media for storing electronic data (e.g., including instructions).

The memory 312 may include one or more of the following in an embodiment: an operating system (O/S) 332, application 334, device driver 336, buffers 338-A through 338-N (collectively referred to herein as “buffers 338” or “buffer 338”), descriptors 340-A through 340-N (collectively referred to herein as “descriptors 340” or “descriptor 340”), and protocol driver 342. Programs (e.g., the application 334) and/or data stored in the memory 312 may be swapped into the disk drive 328 as part of memory management operations. Further, the application(s) 334 may execute (on the processor(s) 302) to communicate one or more data packets with one or more computing devices that communicate via the network 331.

In an embodiment, the application 334 may utilize the O/S 332 to communicate with various components of the system 300, e.g., through the device driver 336. Hence, the device driver 336 may include network adapter (330) specific commands to provide a communication interface between the O/S 332 and the network adapter 330. For example, as will be further discussed with reference to FIG. 4, the device driver 336 may allocate one or more source buffers (338) to store packet data. One or more descriptors (340) may respectively point to the source buffers 338. A protocol driver 342 may implement a protocol driver to process packets sent over the network 331, according to one or more protocols.

In an embodiment, the O/S 332 may include a protocol stack that provides the protocol driver 342. A protocol stack generally refers to a set of procedures or programs that may be executed to process packets sent over a network (331), where the packets may conform to a specified protocol. For example, TCP/IP (Transport Control Protocol/Internet Protocol) packets may be processed using a TCP/IP stack. In an embodiment, the device driver 336 may indicate the source buffers 338 to the protocol driver 342 for processing, e.g., via the protocol stack. The protocol driver 342 may either copy the buffer content (338) to its own protocol buffer (not shown) or use the original buffer(s) (338) indicated by the device driver 336.

As illustrated in FIG. 3, the network adapter 330 may include a (network) protocol layer 350 for implementing the physical communication layer to send and receive network packets to and from remote devices over the network 331. The network adapter 330 may further include a DMA (direct memory access) engine 352, which reads data from buffers (338) assigned to descriptors (340). Additionally, the network adapter 330 may include a network adapter controller 354, which includes hardware (e.g., logic circuitry) and/or a programmable processor to perform adapter-related operations. In an embodiment, the adapter controller 354 may be a MAC (media access control) component. The network adapter 330 may further include a memory 356, such as volatile and/or nonvolatile memory, and may include one or more cache(s). Further operations of components of the system 300 will now be discussed with reference to FIG. 4.

FIG. 4 illustrates a block diagram of an embodiment of a method 400 to send a single uncacheable write request for a plurality of uncacheable write requests to the same address. In an embodiment, various components discussed with reference to FIGS. 1-3 and 5 may be utilized to perform one or more of the operations discussed with reference to FIG. 4. In one embodiment, microcode stored in the uROM 212 may be used to configure various hardware components of the core 106, e.g., for sending a single uncacheable write request in place of a plurality of uncacheable write requests to the same address.

Referring to FIGS. 1-4, at an operation 402, a write request may be received by the processor core 106 (or otherwise fetched by the fetch unit 202 such as discussed with reference to FIG. 2). For example, an application program (334) executing on a processor core (106) may issue a write request, e.g., requesting that data be sent to an I/O device (e.g., network adapter 330) for dispatch over a computer network (331). A decode unit (204) may decode the instruction that corresponds to the write request (404). In an embodiment, the decode unit (204) may decode an instruction to determine whether the instruction corresponds to an uncacheable write request, and may further store information corresponding to the decoded instruction in a memory map table (205), e.g., by updating the memory map table 205 at an operation 406.

In one embodiment, for each decoded write (or store) instruction received at operation 402, the memory map table 205 may store a virtual address 218 (e.g., that is reference or used by the application 334), a physical address 220 (e.g., that identifies a physical address in a memory such as the memory 312 corresponding to the virtual address 218), and a write request type 222 (e.g., which identifies the type of a write request received at operation 402). In an embodiment, the write request type (222) may correspond to one of a write-back memory transaction, a write-through memory transaction, a write-combining memory transaction, or an uncacheable write memory transaction. Further details regarding an uncacheable write memory transaction is discussed with reference to operation 414 below.

At an operation 408, one or more components of the processor core 106 may perform operation(s) (or process uops) corresponding to the decoded write request (404), for example, such as discussed with reference to FIG. 2. In an embodiment, after an application (334) issues a send call or request, e.g., to send data to the network adapter 330 for dispatch over the network 331, the driver(s) 336 and 342 may perform one or more operations corresponding to generating a packet for transmission over the network 331, such as performing tasks associate with various layers of a network stack. Also, the device driver 336 may generate one or more corresponding descriptors (340) for the generated packet.

At an operation 410, the execution unit 208 may generate and send an uncacheable write request to the bus queue 216 for storage. In an embodiment, the bus queue 216 may temporarily store the information that is to be communicated to various components in communication with the interconnection 104 and/or 112. Logic provided within the processor core 106 (e.g., within the bus unit 214 in an embodiment) may access the entries within the bus queue 216 to determine whether a plurality of uncacheable write requests to the same address (e.g., the same physical address) are pending transmission by the bus unit 214. In an embodiment, the logic may determine the type of a write request by accessing a corresponding entry in the memory map table 205 (e.g., the corresponding write request type entry (222)).

At an operation 414, if a plurality of uncacheable write requests to the same address are pending transmission (412), logic provided within the processor core 106 (e.g., within the bus unit 214 in an embodiment) may send a single uncacheable write request for the plurality of uncacheable write requests over an interconnection (e.g., interconnections 104, 112, and/or 304). In an embodiment, the single uncacheable write request (414) may be the last (or most recent) one of the plurality of uncacheable write requests that are pending transmission in the bus queue 214. Furthermore, the plurality of the uncacheable write requests pending transmission may be sequential in an embodiment. In one embodiment, the operation 414 may remove all but the most recent (or last) one of the plurality of uncacheable write requests from the bus queue 216. Hence, at the operation 414, logic within the processor core 106 (e.g., logic within the bus unit 214 in an embodiment) may replace the plurality of uncacheable write requests with the most recent one of the plurality of uncacheable write requests. Furthermore, in embodiments where uncacheable write requests may wait for a snoop result (e.g., to acknowledge successful transmission of the write request), a different instruction may be utilized to distinguish the combined uncacheable write request of the operation 414. Moreover, the reduction of delay corresponding to the wait for the snoop results may improve performance of a processor. Otherwise, if the operation 412 determines that only one uncacheable write request is pending transmission, the bus unit 214 may send the pending uncacheable write request at an operation 416.

In one embodiment, the source buffers 338 may be implemented as a circular buffer. In such an embodiment, to send the uncacheable write requests discussed with reference to operations 414 and 416, the core 106 may update a register of a device in communication with the core 106 (such as a head pointer register 360 within the network adapter 330) to indicate that one or more write operations are pending execution by the device (330). In an embodiment, the register 360 may be memory mapped. Hence, the core 106 may update the corresponding location within the memory 312 instead of directly writing to the register 360.

In an embodiment, to update the register 360, the core 106 may write the address of a head descriptor to the register 360, or its corresponding memory-mapped location in the memory 312. The DMA engine 352 may periodically or continuously check the register 360 to determine if the network adapter 330 has tasks pending. Once the register 360 is updated by a component of the system 300 (e.g., the processor core 106), the DMA engine 352 may use the value stored in the register 360 to obtain the corresponding source data from one or more source buffers (338) for dispatch over the network 331. Accordingly, sending the last uncacheable write request at the operation 414 may include updating a register (360) with a value corresponding to one of the descriptors 340. Once the network adapter 330 receives the descriptor information, the DMA engine 352 may transfer data stored in the source buffers (338) starting from the location identified by the head pointer register 360 (e.g., head of the circular buffer) until all pending data in the source buffers 338 have been transmitted over the network 331. Accordingly, in an embodiment, sending the single uncacheable write request at operation 414 may result in the performance of one or more operations (e.g., all operations in one embodiment) corresponding to the plurality of uncacheable write requests of operation 412.

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 312 of FIG. 3.

In an embodiment, the processors 502 and 504 may be one of the processors 302 discussed with reference to FIG. 3. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537.

At least one embodiment of the invention may be provided within the processors 502 and 504. For example, one or more of the cores 106 and/or cache 108 of FIG. 1 may be located within the processors 502 and 504. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may communicate with a bus 540 using a PtP interface circuit 541. The bus 540 may have one or more devices that communicate with it, such as a bus bridge 542 and I/O devices 543. Via a bus 544, the bus bridge 543 may communicate with other devices such as a keyboard/mouse 545, communication devices 546 (such as modems, network interface devices (e.g., the adapter 330 of FIG. 3), or other communication devices that may communicate with the computer network 331), audio I/O device, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first logic to determine whether a plurality of uncacheable write requests to an address are pending transmission; and
a second logic to send a single uncacheable write request to perform operations corresponding to the plurality of uncacheable write requests.

2. The apparatus of claim 1, further comprising a queue to store the plurality of uncacheable write requests that are pending transmission.

3. The apparatus of claim 1, wherein the single uncacheable write request comprises a most recent one of the plurality of uncacheable write requests.

4. The apparatus of claim 1, wherein the address is a physical address corresponding to a location in a memory.

5. The apparatus of claim 1, further comprising a memory to store a plurality of source buffers that store data corresponding to the plurality of uncacheable write requests.

6. The apparatus of claim 1, further comprising a circular buffer that stores source data corresponding to the plurality of uncacheable write requests.

7. The apparatus of claim 1, further comprising a decode unit to:
decode an instruction to determine whether the instruction corresponds to an uncacheable write request; and
store information corresponding to the decoded instruction in a memory map table.

8. The apparatus of claim 1, further comprising a memory map table to store information corresponding to the plurality of uncacheable write requests, wherein the stored information for each of the plurality of uncacheable write requests comprises one or more of a virtual address, a physical address, and a write request type.

9. The apparatus of claim 8, wherein the write request type corresponds to one of a write-back memory transaction, a write-through memory transaction, a write-combining memory transaction, or an uncacheable write memory transaction.

10. The apparatus of claim 1, further comprising a memory to store a plurality of descriptors that point to a plurality of source buffers, wherein the source buffers store data corresponding to the plurality of uncacheable write requests.

11. The apparatus of claim 1, wherein the plurality of the uncacheable write requests are sequential.

12. The apparatus of claim 1, further comprising a head pointer register to store a head pointer that points to a location in a memory corresponding to source data for the plurality of uncacheable write requests.

13. The apparatus of claim 1, further comprising a bus unit to transmit the single uncacheable write request via a bus.

14. The apparatus of claim 1, further comprising an input/output device to transmit data corresponding to the plurality of uncacheable write requests in response to the single uncacheable write request.

15. The apparatus of claim 1, further comprising a processor that comprises a plurality of processor cores, each of the processor cores comprising one or more of the first logic or the second logic.

16. A method comprising:
determining whether a plurality of uncacheable write requests to an address are pending transmission;
sending a single uncacheable write request instead of sending the plurality of uncacheable write requests; and
performing operations corresponding to the plurality of uncacheable write requests in response to the single uncacheable write request.

17. The method of claim 16, further comprising storing information corresponding to a decoded instruction in a memory map table.

18. The method of claim 16, further comprising storing the plurality of uncacheable write requests in a queue.

19. The method of claim 16, further comprising decoding an instruction to determine whether the instruction corresponds to an uncacheable write request.

20. The method of claim 16, further comprising storing source data corresponding to the plurality of uncacheable write requests in a plurality of source buffers.

21. The method of claim 16, wherein sending the single uncacheable write request comprises sending a most recent one of the plurality of uncacheable write requests.

22. The method of claim 16, further comprising updating a device register in response to the single uncacheable write request.

23. A system comprising:
a first memory to store source data;
a second memory to store a plurality of uncacheable write requests to a same physical address in the first memory;
a processor core to replace the plurality of uncacheable write requests with a most recent one of the plurality of uncacheable write requests.

24. The system of claim 23, wherein the processor core updates a register of an input/output device with a value corresponding to the most recent one of the plurality of uncacheable write requests.

25. The system of claim 23, further comprising an input/output device to transmit the source data corresponding to the plurality of the uncacheable write requests.

26. The system of claim 23, further comprising a bus unit to transmit the most recent one of the plurality of uncacheable write requests to an input/output device.

27. The system of claim 23, further comprising an audio device.

28. A computer-readable medium comprising one or more instructions that when executed on a processor configure the processor to:
determine whether a plurality of uncacheable write requests to an address are pending transmission;
send a single uncacheable write request for the plurality of uncacheable write requests; and
perform operations corresponding to the plurality of uncacheable write requests.

29. The computer-readable medium of claim 28, further comprising one or more instructions to configure the processor to store the plurality of uncacheable write requests in a queue.

30. The computer-readable medium of claim 28, further comprising one or more instructions to configure the processor to update a device register in response to the single uncacheable write request.

31. A processor comprising:
an execution unit to generate a plurality of uncacheable write requests;
a queue to store the plurality of uncacheable write requests that are pending transmission;
logic to access the queue and determine whether more than one uncacheable write requests to a same address are pending transmission; and
a bus unit to transmit an uncacheable write request in place of the more than one uncacheable write requests to request performance of operations corresponding to the plurality of uncacheable write requests.

32. The processor of claim 31, wherein the uncacheable write request comprises a most recent one of the plurality of uncacheable write requests.

33. The processor of claim 31, wherein the same address is an address corresponding to a physical location in a memory.

34. The processor of claim 31, further comprising a head pointer register to store a head pointer that points to a location in a memory corresponding to source data for the plurality of uncacheable write requests.

35. The processor of claim 31, further comprising an input/output device to transmit data corresponding to the plurality of uncacheable write requests in response to the uncacheable write request.

36. The processor of claim 31, further comprising a memory to store a circular buffer that stores source data corresponding to the plurality of uncacheable write requests.

37. The processor of claim 31, wherein the bus unit comprises the logic to access the queue.

38. The processor of claim 31, further comprising a decode unit to:
decode an instruction to determine whether the instruction corresponds to an uncacheable write request; and
store information corresponding to the decoded instruction in a memory map table.

39. The processor of claim 31, further comprising a plurality of processor cores, each of the processor cores comprising one or more of the execution unit, the bus unit, the queue, and the logic to access the queue.
